(19) United States
(12) Patent Application Publication
(10) Pub. No.: US 2017/0309085 A1
(43) Pub. Date: Oct. 26, 2017

(54) PROVIDING VEHICLE INFORMATION TO A TELEMATICS DEVICE VIA AN EXPANSION DEVICE

(71) Applicant: Verizon Patent and Licensing Inc., Arlington, VA (US)

(72) Inventors: Bryant ELLIOTT, Marietta, GA (US); Gyeong S. KANG, Marietta, GA (US)

(21) Appl. No.: 15/136,351

(22) Filed: Apr. 22, 2016

(51) Int. Cl. G07C 5/00; H04L 29/08; H04W 4/04; H04W 84/04

(52) U.S. Cl. CPC G07C 5/008; H04W 4/046; H04L 67/12; H04W 84/042

(57) ABSTRACT

A device may receive, via a first interface, vehicle information associated with a plurality of vehicle communication networks. The device may provide, via a second interface, a first subset of the vehicle information to a telematics device. The second interface may include an on-board diagnostics interface. The first subset of the vehicle information may be associated with one or more vehicle communication networks, of the plurality of vehicle communication networks, with which the telematics device is configured to communicate. The device may provide, via a third interface, a second subset of the vehicle information to the telematics device. The telematics device may provide the vehicle information to another device. The third interface may include a wireless interface.

### BACKGROUND

A telematics device may interface with a vehicle communication bus (e.g., a controller area network (CAN) bus) via an on-board diagnostics II (OBD-II) port. The telematics device may provide vehicle information to a monitoring device, such that a fleet manager may track a fleet of vehicles.

### BRIEF DESCRIPTION OF THE DRAWINGS

FIGS. 1A and 1B are diagrams of an overview of an example implementation described herein;

FIG. 2 is a diagram of an example environment in which systems and/or methods, described herein, may be implemented;

FIG. 3 is a diagram of example components of one or more devices of FIG. 2;

FIG. 4 is a diagram of example components of one or more devices of FIG. 2; and

FIG. 5 is a flow chart of an example process for providing vehicle information to a telematics device via an expansion device.

### DETAILED DESCRIPTION OF PREFERRED EMBODIMENTS

The following detailed description of example implementations refers to the accompanying drawings. The same reference numbers in different drawings may identify the same or similar elements.

A vehicle (e.g., an automobile) may include self-diagnostic and/or reporting capabilities. The vehicle may include multiple vehicle communication networks (VCNs) (e.g., controller area network (CAN) buses) through which multiple control devices may provide and/or receive information. A control device may include an electronic control unit (ECU), a sensor device (e.g., an engine temperature sensor and/or an alarm activation sensor), or the like. A telematics device (e.g., a telematics dongle) may interface with a control device associated with the vehicle communication network via an OBD-II port of the vehicle, and may provide vehicle information to a telematics monitoring device (e.g., a server device and/or a client device) via a network (e.g., a cellular network).

A first type of telematics device (e.g., a consumer telematics device) may be configured to communicate with particular control devices, sensors, and/or particular VCNs (e.g., may be configured to use a particular communication protocol and/or may include a particular pin configuration). A second type of telematics device (e.g., a fleet telematics device) may be configured to communicate with additional control devices, sensors, and/or additional VCNs, may include additional ports (e.g., serial ports) that allow communication with peripheral devices, may include an internal battery to maintain a cellular connection in the event of a loss of vehicle power, may include additional functionality, additional features, or the like. An organization (e.g., a company) may use fleet telematics devices to monitor and/or track a fleet of vehicles.

However, in some cases, the organization may not require the additional features and/or functionality associated with the fleet telematics device. In such cases, the fleet telematics device may be more costly, may consume additional network resources, and/or processor and/or memory resources associated with the telematics monitoring device by providing the telematics monitoring device with information with which the organization may not be interested. Implementations described herein may enable the extensibility of functionality of a consumer telematics device via an expansion device. For example, the expansion device may be capable of communicating with additional control devices and/or VCNs of the vehicle, may include additional ports, and/or may enable a consumer telematics device to be used in association with particular vehicles (e.g., heavy-duty trucks). Additionally, the expansion device may provide information, associated with additional control devices, VCNs, and/or connected peripheral devices, to the consumer telematics device via a wireless interface (e.g., a Bluetooth interface).

In this way, an organization may utilize consumer telematics devices, in combination with expansion devices, to track and/or monitor a fleet of vehicles. Additionally, in this way, an organization may extend the functionality of the consumer telematics device, as desired, via the expansion device. In this way, network resources and/or processor and/or memory resources of a telematics monitoring device may be conserved by enabling and/or extending functionality of the consumer telematics device as desired (e.g., as compared to enabling unnecessary functionality via a fleet telematics device). Additionally, implementations described herein may obviate a need for cellular re-certification associated with expansion devices and/or may reduce a quantity of resources needed to develop expansion devices.

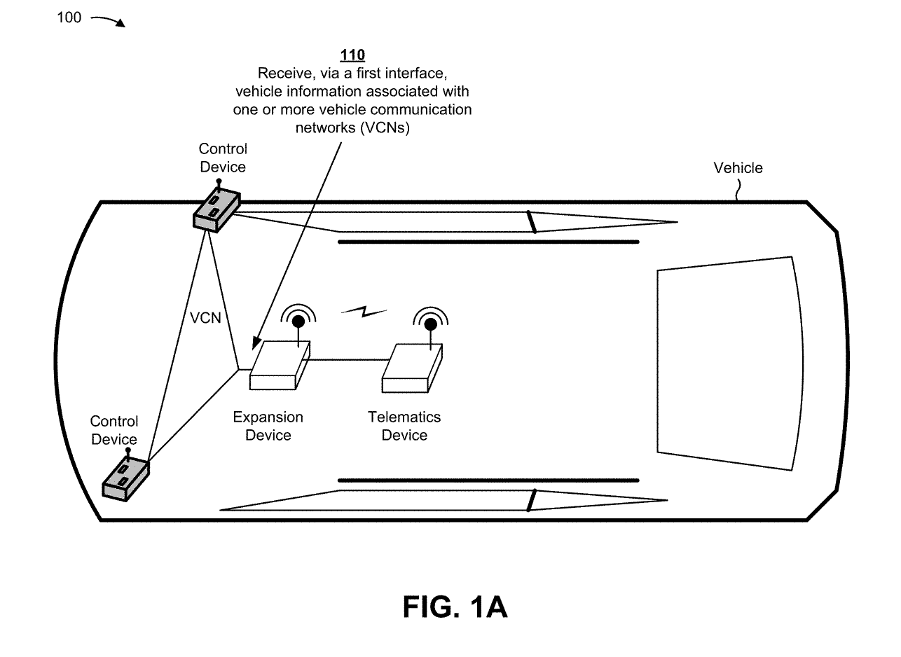

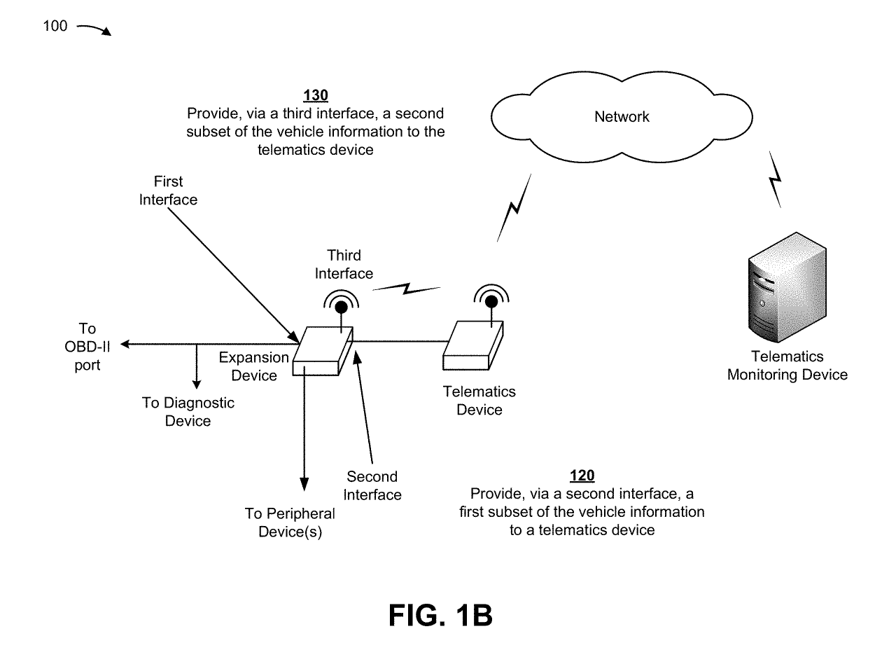

FIGS. 1A and 1B are diagrams of an overview of an example implementation 100 described herein. As shown in FIG. 1A, and by reference number 110, an expansion device may receive, via a first interface, vehicle information associated with one or more VCNs. For example, the expansion device may connect to an OBD-II port of a vehicle via the first interface. Vehicle information may include information associated with the vehicle's electrical, mechanical, and/or emission systems. For example, the expansion device may receive vehicle information from one or more control devices (e.g., ECUs) via one or more VCNs.

As shown in FIG. 1B, and by reference number 120, the expansion device may provide, via a second interface, a first subset of the vehicle information to a telematics device. For example, the expansion device may communicate, via a wired connection, with the telematics device via the second interface. In some implementations, the first subset of the vehicle information may include vehicle information associated with a particular control device and/or a particular VCN with which the telematics device may be configured to communicate. For example, the telematics device may include a particular pin configuration and/or may be configured to communicate with the particular control device and/or VCN using a particular communication protocol. In this way, the expansion device may provide signals, that include the first subset of the vehicle information, to the telematics device via the second interface.

As shown by reference number 130, the expansion device may provide, via a third interface, a second subset of the vehicle information to the telematics device. For example, the third interface may include a personal area network (PAN) interface (e.g., a Bluetooth interface, a near field communication (NFC) interface, or the like). In some implementations, the second subset of the vehicle information may include vehicle information associated with a particular control device and/or a particular VCN with which the telematics device may not be configured to communicate (e.g., the telematics device may not include a pin configuration and/or may not be configured to use a particular communication protocol associated with that particular VCN). Additionally, the expansion device may not be capable of providing the second subset of the vehicle information to the telematics device via the second interface (e.g., because the second interface may include a particular pin usage configuration and/or communication protocol). Additionally, communication issues may result if the expansion device attempts to provide the second subset of the vehicle information to the telematics device via the second interface (e.g., one or more pins associated with the second interface may be associated with particular communication protocols). Additionally, the expansion device may provide information, associated with one or more peripheral devices (not pictured), to the telematics device via the third interface, as described elsewhere herein.

In this way, the expansion device may communicate with the telematics device via the third interface (e.g., provide the second subset of the vehicle information and/or other information), thereby extending the functionality of the telematics device. Additionally, the telematics device may provide, to a telematics monitoring device, the vehicle information (e.g., the first subset and/or the second subset), location information, and/or the like, via a wireless interface (e.g., a cellular interface). In this way, the telematics monitoring device may provide information for display, thereby allowing a user (e.g., a fleet manager) to monitor the vehicle.

Implementations described herein enable an expansion device to extend the functionality of a telematics device. For example, the expansion device may communicate with additional control devices, VCNs, and/or peripheral devices, and may provide information to the telematics device. In this way, an organization may utilize a particular telematics device (e.g., a consumer telematics device, such as a standard OBD-II telematics dongle) and the expansion device to monitor a particular vehicle (e.g., a fleet vehicle, such as a heavy-duty truck). Additionally, in this way, an organization may extend the functionality of the telematics device, as desired, via the expansion device. In this way, the expansion device may conserve processor and/or memory resources of the telematics monitoring device, and/or may conserve network resources by providing the telematics monitoring device with a particular quantity of information (e.g., instead of providing the telematics monitoring device with undesired information).

As indicated above, FIGS. 1A and 1B are provided merely as an example. Other examples are possible and may differ from what was described with regard to FIGS. 1A and 1B.

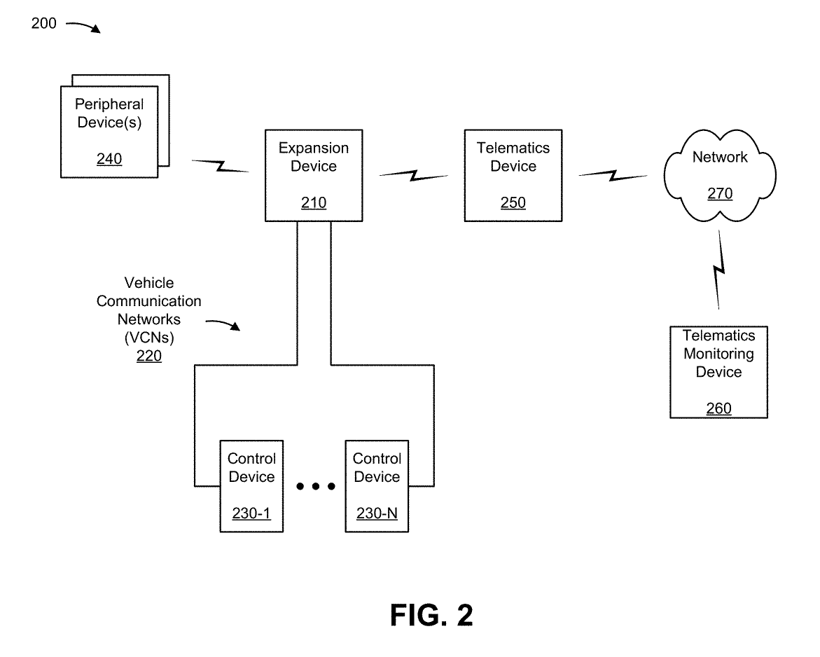

FIG. 2 is a diagram of an example environment 200 in which systems and/or methods, described herein, may be implemented. As shown in FIG. 2, environment 200 may include an expansion device 210, vehicle communication networks (VCNs) 220 (hereinafter referred to collectively as “VCNs 220,” and individually as “VCN 220”), one or more control devices 230-1 through 230-N (N≧1) (hereinafter referred to collectively as “control devices 230,” and individually as “control device 230”), one or more peripheral devices 240 (hereinafter referred to collectively as “peripheral devices 240,” and individually as “peripheral device 240”), a telematics device 250, a telematics monitoring device 260, and a network 270. Devices of environment 200 may interconnect via wired connections, wireless connections, or a combination of wired and wireless connections.

Expansion device 210 includes one or more devices capable of receiving, generating, storing, processing, and/or providing vehicle information. For example, expansion device 210 may include a computing device. In some implementations, expansion device 210 may be connected with, coupled to, and/or used in association with VCN 220. For example, expansion device 210 may include a dongle that interfaces with VCN 220 through an OBD (e.g., OBD-II) port of the vehicle.

VCN 220 includes one or more wired and/or wireless networks. For example, VCN 220 may include a CAN that allows expansion device 210, telematics device 250, and/or peripheral device 240 to communicate with one or more control devices 230, and/or that allows a particular control device 230 to communicate with one or more other control devices 230. In some implementations, VCN 220 may include a vehicle bus. In some implementations, VCN 220 may operate using a message-based protocol network, such as a Society of Automotive Engineers (SAE) J1850 pulse-width modulation (PWM) protocol network, an SAE J1850 variable pulse-width (VPW) protocol network, an International Standards Organization (ISO) 914102 protocol network, an ISO 14230 Keyword Protocol 2000 (KWP2000) network, an ISO 15765 CAN protocol network (e.g., a CAN bus network), an SAE J2411 Single-Wire (SWC) CAN protocol network, an SAE J19319 protocol network, or the like. In some implementations, VCN 220 may facilitate the transfer of vehicle information associated with one or more control devices 230.

Control device 230 includes one or more devices capable of receiving, generating, processing, storing, and/or providing vehicle information. For example, control device 230 may include an ECU (e.g., an engine control module (ECM), a powertrain control module (PCM), a transmission control module (TCM), a brake control module (BCM), or another control module), a sensor (e.g., a fuel pressure sensor, an engine temperature sensor, a tire pressure sensor, or another sensor), or the like. In some implementations, control device 230 may include a communication device capable of receiving information from and/or providing information to expansion device 210, peripheral device 240, telematics device 250, and/or another control device 230 via VCN 220.

Peripheral device 240 includes one or more devices capable of receiving, generating, processing, storing, and/or providing vehicle information. For example, peripheral device 240 may include a global positioning system (GPS) device, an alarm device, a sensor device, a display device, or the like. In some implementations, peripheral device 240 may be connected with, coupled to, and/or used in association with expansion device 210.

Telematics device 250 includes one or more devices capable of receiving, generating, storing, processing, and/or providing vehicle information via network 270. For example, telematics device 250 may include a computing device. In some implementations, telematics device 250 may be connected with, coupled to, and/or used in association with VCN 220, such as a telematics dongle that interfaces with VCN 220 through an OBD-II port of the vehicle. In some implementations, telematics device 250 may receive vehicle information via expansion device 210, and may provide vehicle information to telematics monitoring device 260 (e.g., via network 270).

Telematics monitoring device 260 includes one or more devices capable of receiving, generating, storing, processing, and/or providing vehicle information. For example, telematics monitoring device 260 may include a computing device, such as a desktop computer, a laptop computer, a tablet computer, a server device (e.g., a cloud server or a web server), a mobile phone (e.g., a smart phone or a radiotelephone), or a similar type of device. In some implementations, telematics monitoring device 260 may receive vehicle information from telematics device 250, and may provide the vehicle information for display (e.g., via a user interface).

Network 270 includes one or more wired and/or wireless networks. For example, network 270 may include a cellular network (e.g., a long-term evolution (LTE) network, a third generation (3G) network, a code division multiple access (CDMA) network, etc.), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, a cloud computing network, or the like, and/or a combination of these or other types of networks.

The number and arrangement of devices and networks shown in FIG. 2 are provided as an example. In practice, there may be additional devices and/or networks, fewer devices and/or networks, different devices and/or networks, or differently arranged devices and/or networks than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) of environment 200 may perform one or more functions described as being performed by another set of devices of environment 200.

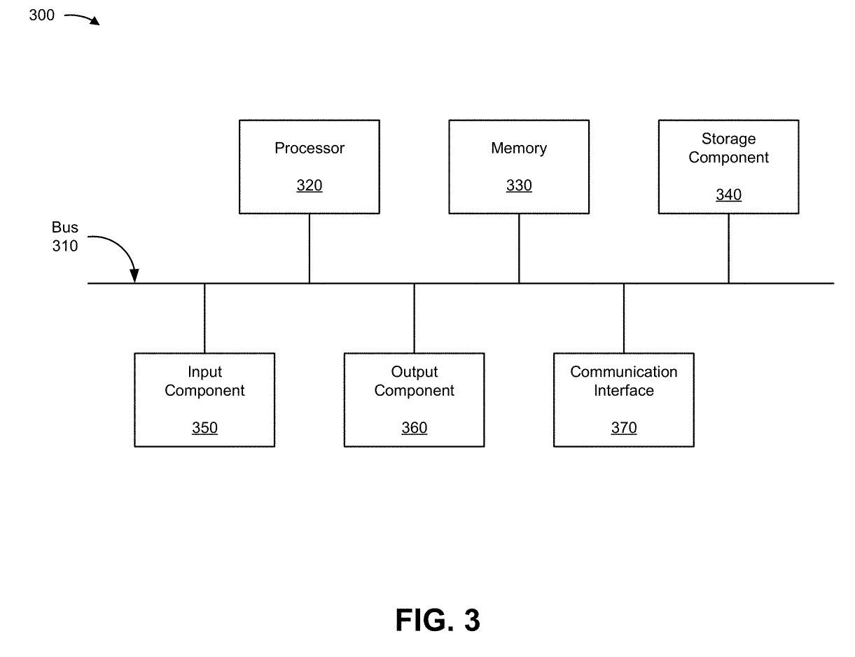

FIG. 3 is a diagram of example components of a device 300. Device 300 may correspond to expansion device 210, control device 230, peripheral device 240, telematics device 250, and/or telematics monitoring device 260. In some implementations, expansion device 210, control device 230, peripheral device 240, telematics device 250, and/or telematics monitoring device 260 may include one or more devices 300 and/or one or more components of device 300. As shown in FIG. 3, device 300 may include a bus 310, a processor 320, a memory 330, a storage component 340, an input component 350, an output component 360, and a communication interface 370.

Bus 310 includes a component that permits communication among the components of device 300. Processor 320 is implemented in hardware, firmware, or a combination of hardware and software. Processor 320 includes a processor (e.g., a central processing unit (CPU), a graphics processing unit (GPU), and/or an accelerated processing unit (APU)), a microprocessor, a microcontroller, and/or any processing component (e.g., a field-programmable gate array (FPGA) and/or an application-specific integrated circuit (ASIC)) that interprets and/or executes instructions. In some implementations, processor 320 includes one or more processors capable of being programmed to perform a function. Memory 330 includes a random access memory (RAM), a read only memory (ROM), and/or another type of dynamic or static storage device (e.g., a flash memory, a magnetic memory, and/or an optical memory) that stores information and/or instructions for use by processor 320.

Storage component 340 stores information and/or software related to the operation and use of device 300. For example, storage component 340 may include a hard disk (e.g., a magnetic disk, an optical disk, a magneto-optic disk, and/or a solid state disk), a compact disc (CD), a digital versatile disc (DVD), a floppy disk, a cartridge, a magnetic tape, and/or another type of non-transitory computer-readable medium, along with a corresponding drive.

Input component 350 includes a component that permits device 300 to receive information, such as via user input (e.g., a touch screen display, a keyboard, a keypad, a mouse, a button, a switch, and/or a microphone). Additionally, or alternatively, input component 350 may include a sensor for sensing information (e.g., a GPS component, an accelerometer, a gyroscope, and/or an actuator). Output component 360 includes a component that provides output information from device 300 (e.g., a display, a speaker, and/or one or more light-emitting diodes (LEDs)).

Communication interface 370 includes a transceiver-like component (e.g., a transceiver and/or a separate receiver and transmitter) that enables device 300 to communicate with other devices, such as via a wired connection, a wireless connection, or a combination of wired and wireless connections. Communication interface 370 may permit device 300 to receive information from another device and/or provide information to another device. For example, communication interface 370 may include an Ethernet interface, an optical interface, a coaxial interface, an infrared interface, a radio frequency (RF) interface, a universal serial bus (USB) interface, a Wi-Fi interface, a cellular network interface, or the like.

Device 300 may perform one or more processes described herein. Device 300 may perform these processes in response to processor 320 executing software instructions stored by a non-transitory computer-readable medium, such as memory 330 and/or storage component 340. A computer-readable medium is defined herein as a non-transitory memory device. A memory device includes memory space within a single physical storage device or memory space spread across multiple physical storage devices.

Software instructions may be read into memory 330 and/or storage component 340 from another computer-readable medium or from another device via communication interface 370. When executed, software instructions stored in memory 330 and/or storage component 340 may cause processor 320 to perform one or more processes described herein. Additionally, or alternatively, hardwired circuitry may be used in place of or in combination with software instructions to perform one or more processes described herein. Thus, implementations described herein are not limited to any specific combination of hardware circuitry and software.

The number and arrangement of components shown in FIG. 3 are provided as an example. In practice, device 300 may include additional components, fewer components, different components, or differently arranged components than those shown in FIG. 3. Additionally, or alternatively, a set of components (e.g., one or more components) of device 300 may perform one or more functions described as being performed by another set of components of device 300.

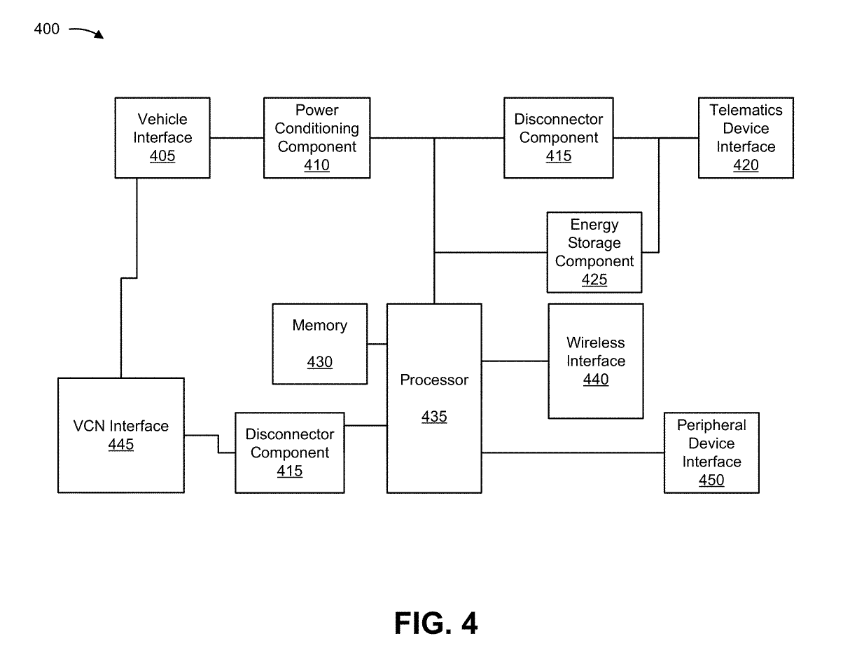

FIG. 4 is a diagram of example components of a device 400. Device 400 may correspond to expansion device 210, peripheral device 240, and/or telematics device 250. In some implementations, expansion device 210, peripheral device 240, and/or telematics device 250 may include one or more devices 400 and/or one or more components of device 400. As shown in FIG. 4, device 400 may include a vehicle interface 405, a power conditioning component 410, a disconnector component 415, a telematics device interface 420, an energy storage component 425, a memory 430, a processor 435, a wireless interface 440, a VCN interface 445, and a peripheral device interface 450.

Vehicle interface 405 includes a component that permits expansion device 210, peripheral device 240, and/or telematics device 250 to communicate with control devices 230 via VCN 220. In some implementations, vehicle interface 405 may include a connector (e.g., an OBD-II connector, such as an SAE J1962 connector) that may interface with an OBD-II port of a vehicle. In some implementations, vehicle interface 405 may include a 16-pin connector, a 6-pin connector, a 9-pin connector, or the like. Additionally, or alternatively, vehicle interface 405 may permit signals to be provided to and/or received from control devices 230 via VCN 220. Additionally, or alternatively, vehicle interface 405 may permit power to be received from a power supply (e.g., a 12V battery or a 24V battery) of a vehicle.

Power conditioning component 410 includes a component that manages power input from a power supply of a vehicle, and provides power to other components of device 400. In some implementations, power conditioning component 410 may receive power from a vehicle's power supply via vehicle interface 405. In some implementations, power conditioning component 410 includes a component (e.g., a switching regulator, such as a “buck” or “step-down” regulator) that may switch a voltage associated with a power supply of a vehicle (e.g., 24V) to a lower voltage (e.g., 12V) and may provide the lower voltage to telematics device 250 and/or peripheral device 240. Telematics device 250 may support a 12V system, and/or may not be capable of functioning in association with a vehicle including a 24V power supply (e.g., without expansion device 210). Functionality associated with 24V system support may result in an increased cost associated with telematics device 250. Additionally, or alternatively, power conditioning component 410 may switch a voltage (e.g., 12V) associated with a power supply of the vehicle to a lower voltage (e.g., 3.3V or 5V), and may provide the lower voltage to another component of device 400.

Additionally, or alternatively, power conditioning component 410 may provide power to energy storage component 425, which may allow energy storage component 425 to provide power to telematics device 250 and/or peripheral device 240 in the event of a disconnect of expansion device 210 from an OBD-II port of a vehicle. In some implementations, power conditioning component 410 includes a component (e.g., a switching regulator, such as a “boost” or “step-up” regulator) that switches a voltage associated with energy storage component 425 (e.g., 3.6V) to a higher voltage (e.g., 12V) and may provide the higher voltage to telematics device 250.

Disconnector component 415 includes a component that may prevent expansion device 210 and/or telematics device 250 from communicating with control devices 230 via VCN 220. In some implementations, device 400 may detect that a diagnostic device (e.g., an OBD-II scan tool) is in communication with VCN 220, and may prevent signals from being provided to VCN 220 via telematics device interface 420 and/or VCN interface 445 while the diagnostic device is in communication with VCN 220. Additionally, or alternatively, device 400 may detect that a particular cable is connected to peripheral device interface 450 (e.g., based on a pin configuration and/or a signal), and may prevent signals from being provided from expansion device 210 to VCN 220 via VCN interface 445 while the particular cable is connected to peripheral device interface 450.

Telematics device interface 420 includes a component that permits telematics device 250 to communicate with control devices 230 via VCN 220. In some implementations, telematics device interface 420 may include a connector (e.g., an OBD-II connector) that interfaces with telematics device 250.

Energy storage component 425 includes a component (e.g., a battery, such as a nickel-metal hydride (NiMH) or a lithium-ion (li-ion) battery, and/or a supercapacitor (SC)) that may store energy and provide power to other components of device 400, telematics device 250, and/or peripheral device 240.

Memory 430 includes a RAM, a ROM, and/or another type of dynamic or static storage device that stores information and/or instructions for use by processor 435. Processor 435 includes a processor, a microprocessor, a microcontroller, and/or any processing component that interprets and/or executes instructions. In some implementations, processor 435 includes one or more processors capable of being programmed to perform a function.

Wireless interface 440 includes a transceiver-like component, such as a transceiver and/or a separate receiver and transmitter, that enables device 400 to communicate with other devices, such as via a wireless connection. For example, wireless interface 440 may permit device 400 to establish a wireless local area network (WLAN) connection, and/or a personal area network (PAN) connection (e.g., a Bluetooth connection, an NFC connection, or the like) with another device.

VCN interface 445 includes a transceiver-like component, such as a transceiver and/or a separate receiver and transmitter, that enables device 400 to communicate with control devices 230 via particular VCNs 220 associated with a vehicle, such as via a wired connection. In some implementations, device 400 may communicate with control devices 230 via particular VCNs 220 using particular pins associated with vehicle interface 405 (e.g., using pins 3 and 11, pin 1, or the like, as specified by SAE J1962), using particular communication protocols, or the like. Telematics device 250 may not support non-standard VCN interfaces, which may vary among different vehicle manufacturers. Expansion device 210 may provide support for non-standard VCN interfaces.

Peripheral device interface 450 includes a component that permits peripheral device 240 to communicate with control devices 230 via VCN 220. In some implementations, peripheral device interface 450 includes a port (e.g., a serial port) that may connect with a cable (e.g., a cable including a 4-pin connector, or the like) associated with peripheral device 240.

The number and arrangement of components shown in FIG. 4 are provided as an example. In practice, device 400 may include additional components, fewer components, different components, or differently arranged components than those shown in FIG. 4. Additionally, or alternatively, a set of components (e.g., one or more components) of device 400 may perform one or more functions described as being performed by another set of components of device 400.

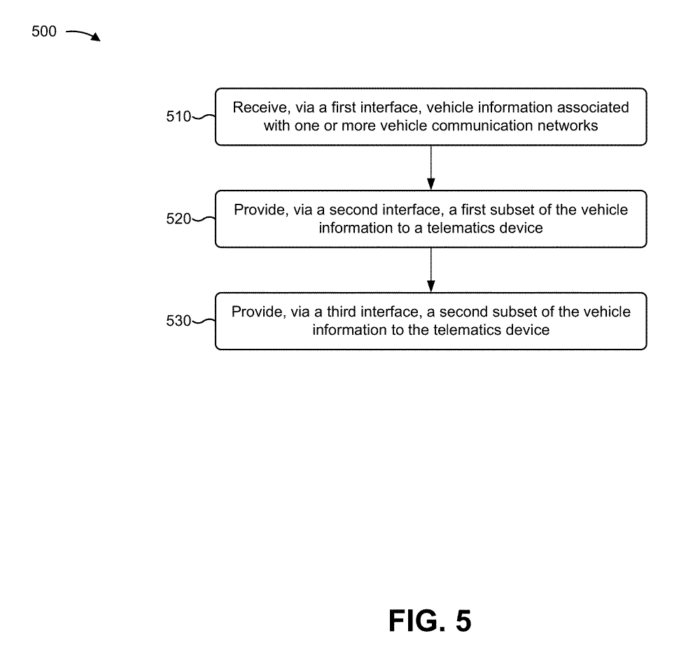

FIG. 5 is a flow chart of an example process 500 for providing vehicle information to a telematics device via an expansion device. In some implementations, one or more process blocks of FIG. 5 may be performed by expansion device 210. In some implementations, one or more process blocks of FIG. 5 may be performed by another device or a group of devices separate from or including expansion device 210, such as control device 230, peripheral device 240, telematics device 250, and/or telematics monitoring device 260.

As shown in FIG. 5, process 500 may include receiving, via a first interface, vehicle information associated with one or more vehicle communication networks (block 510). For example, expansion device 210 may receive, via vehicle interface 405, vehicle information associated with one or more VCNs 220. In some implementations, vehicle information may include information associated with control devices 230, such as information associated with a vehicle's electrical, mechanical, and/or emission systems (e.g., a diagnostic trouble code (DTC), an operating temperature, an operating pressure, a fuel level, a battery level, an oil quality, a speed, a mileage, and/or any other information associated with control device 230).

In some implementations, vehicle interface 405 may include an interface that allows expansion device 210 to communicate with one or more control devices 230 via one or more VCNs 220. For example, vehicle interface 405 may mate with an associated connector of an OBD-II port of the vehicle. In some implementations, a cable (e.g., a wiring harness) may connect vehicle interface 405 of expansion device 210 with an OBD-II port of the vehicle. For example, the cable (e.g., a Y-cable) may include a first connector that mates with an OBD-II port of the vehicle, a second connector that mates with vehicle interface 405 of expansion device 210, and a third connector that mates with a diagnostic device (e.g., an OBD-II scan tool), as described in more detail elsewhere herein.

In some implementations, a vehicle's OBD-II connector (e.g., female OBD-II connector) may be removed from an initial location (e.g., located under the vehicle's dashboard), and may be connected to the first connector of the cable. Additionally, the third connector of the cable may be secured in the initial location, thereby allowing a diagnostic device to interface with the third connector. In this way, expansion device 210 may be positioned within the vehicle such that expansion device 210 and/or telematics device 250 may not conflict with operation of a vehicle pedal (e.g., a throttle, a clutch, and/or a brake pedal), and/or may not be susceptible to tampering (e.g., theft and/or disengagement). In some implementations, expansion device 210 may include fastening elements (e.g., cable tie hooks) to secure telematics device 250, peripheral device 240, and/or one or more cables associated with expansion device 210, telematics device 250, and/or peripheral device 240.

In some implementations, expansion device 210 may communicate with one or more VCNs 220 via vehicle interface 405. Additionally, or alternatively, expansion device 210 may determine one or more communication protocols being used by the one or more VCNs 220. For example, a communication protocol may refer to one or more digital rules for message exchange with control device 230 via VCN 220, such as a message format rule (e.g., a connector pin usage configuration, a voltage interpretation configuration, a message length limit, and/or a transmission mode configuration), a message interpretation rule (e.g., an identification of one or more message codes used to request and interpret information, such as a code for requesting fuel system status and/or a code for providing a value for a fuel pressure), or the like. In some implementations, expansion device 210 may determine the communication protocol(s) being used by the one or more VCNs 220, and may communicate with the one or more VCNs using the determined communication protocol(s). For example, expansion device 210 may determine the communication protocol(s) being used by the one or more VCNs 220 based on stored information that identifies the communication protocol(s), based on receiving information that identifies the communication protocol(s), or the like.

In some implementations, expansion device 210 may receive power from a power supply associated with the vehicle (e.g., a 12V or 24V battery associated with the vehicle) via vehicle interface 405. In some implementations, expansion device 210 (e.g., power conditioning component 410) may supply regulated power to one or more components of expansion device 210, telematics device 250, and/or peripheral device 240. Additionally, or alternatively, expansion device 210 (e.g., energy storage component 425) may supply power to telematics device 250 and/or peripheral device 240 in the event that expansion device 210 is disconnected from the vehicle, and/or in the event that a voltage associated with a power supply of the vehicle satisfies a threshold voltage (e.g., the power supply is incapable of providing power to expansion device 210).

As further shown in FIG. 5, process 500 may include providing, via a second interface, a first subset of the vehicle information to a telematics device (block 520). For example, expansion device 210 may provide, via telematics device interface 420, a first subset of the vehicle information to telematics device 250. In some implementations, telematics device interface 420 may include an interface that allows expansion device 210 to communicate with telematics device 250 and/or allows telematics device 250 to communicate with one or more control devices via one or more VCNs 220. For example, telematics device interface 420 may mate with an associated connector of telematics device 250 (e.g., a 16-pin male OBD-II connector). In some implementations, a cable may connect expansion device 210 and telematics device 250 (e.g., the cable may mate with telematics device interface 420 and with a connector of telematics device 250).

In some implementations, the first subset of the vehicle information may include information associated with one or more control devices 230 that telematics device 250 may communicate with via particular VCNs 220. In some implementations, telematics device 250 may be configured to communicate with a particular VCN 220 (or VCNs 220) associated with the vehicle. For example, telematics device 250 may be configured to use a particular communication protocol (e.g., SAE J1850, ISO 15765-4, SAE J2284, ISO 9141-2, and/or ISO 14230), and/or may be configured to communicate with VCNs 220 using a particular pin configuration (e.g., based on a pinout defined by SAE J1962).

In some implementations, expansion device 210 may provide, to telematics device 250, vehicle information (e.g., signals including the vehicle information) associated with the particular VCN 220 and/or VCNs 220 with which telematics device 250 may communicate. For example, expansion device 210 may provide pass-through signaling between telematics device 250 and control devices 230.

In some implementations, telematics device 250 may receive, from expansion device 210, the first subset of the vehicle information, and may provide the first subset of the vehicle information to telematics monitoring device 260 (e.g., via network 270). Additionally, telematics monitoring device 260 may provide, for display, the first subset of the vehicle information. In this way, a user (e.g., a fleet manager) may monitor the vehicle based on the first subset of the vehicle information.

In some implementations, expansion device 210 may prevent telematics device 250 from communicating with control device 230 via VCN 220. For example, expansion device 210 may detect that a diagnostic device is connected to the OBD-II port of the vehicle (e.g., via the third connector of the cable that connects expansion device 210 to the OBD-II port of the vehicle, as described above). In this case, both the diagnostic device and telematics device 250 may attempt to communicate with control device 230 via VCN 220, thereby causing communication issues (e.g., collisions). Thus, in this case, expansion device 210 (e.g., disconnector component 415) may prevent telematics device 250 from communicating with control device 230 via VCN 220 while the diagnostic device is connected to the OBD-II port of the vehicle, thereby conserving processor resources by reducing communication issues.

In some implementations, expansion device 210 may provide power to telematics device 250 via telematics device interface 420. Additionally, or alternatively, expansion device 210 may provide regulated power to telematics device 250. For example, expansion device 210 (e.g., power conditioning component 410) may switch a voltage associated with a power supply of the vehicle (e.g., 24V) to another voltage (e.g., 12V), and may provide the other voltage to telematics device 250. In this way, expansion device 210 may enable telematics device 250 to be used in association with particular vehicles (e.g., heavy-duty trucks, vehicles that include multiple batteries, and/or vehicles that include batteries having a particular voltage).

Additionally, or alternatively, expansion device 210 may provide power to telematics device 250 via telematics device interface 420 based on detecting that expansion device 210 is disconnected from the OBD-II port of the vehicle and/or based on detecting that a voltage associated with a power supply of the vehicle satisfies a threshold voltage (e.g., the power supply is incapable of providing a particular voltage to telematics device 250). For example, expansion device 210 (e.g., energy storage component 425) may provide power to telematics device 250, thereby allowing telematics device 250 to provide information (e.g., location information, information that identifies an issue associated with the vehicle, or the like) to telematics monitoring device 260 even in the event of a loss of power.

As further shown in FIG. 5, process 500 may include providing, via a third interface, a second subset of the vehicle information to the telematics device (block 530). For example, expansion device 210 may provide, via wireless interface 440, a second subset of the vehicle information to telematics device 250. In some implementations, wireless interface 440 may include a PAN interface (e.g., a Bluetooth interface, an NFC interface, or the like) and may allow expansion device 210 to communicate with telematics device 250.

In some implementations, the second subset of the vehicle information may include information associated with a particular control device 230 and/or a particular VCN 220 with which telematics device 250 is not configured to communicate. For example, telematics device 250 may not be configured with a communication protocol and/or may not include an interface capable of communicating with the particular control device 230 and/or the particular VCN 220. Additionally, or alternatively, expansion device 210 may be configured to communicate with the particular control device 230 and/or the particular VCN 220 (e.g., a single-wire CAN and/or a VCN 220 associated with a communication protocol and/or pin usage configuration that is not defined by SAE J1962).

In some implementations, expansion device 210 may communicate with the particular control device 230 and/or the particular VCN 220 (e.g., via VCN interface 445), and may receive the second subset of the vehicle information. In this case, expansion device 210 may not be capable of providing the second subset of the vehicle information to telematics device 250 via telematics device interface 420 (e.g., based on a communication protocol and/or a pin configuration associated with the telematics device interface 420). In some implementations, expansion device 210 may provide, to telematics device 250, the second subset of the vehicle information via wireless interface 440. In this way, telematics device 250 may receive the second subset of the vehicle information, and may provide the second subset of the vehicle information to telematics monitoring device 260 (e.g., via network 270).

In some implementations, expansion device 210 may receive, from telematics device 250, information via wireless interface 440. For example, expansion device 210 may receive, from telematics device 250, a command, a request message (e.g., a parameter identifier (PID) message that requests diagnostic data associated with control device 230), a configuration message, configuration information (e.g., firmware), or the like. In some implementations, telematics device 250 may receive information from telematics monitoring device 260, and may provide the information to expansion device 210 via wireless interface 440, may update a configuration associated with expansion device 210, or the like.

In some implementations, expansion device 210 may receive a request message from telematics device 250, may provide the request message to control device 230 via VCN 220. Additionally, expansion device 210 may receive a response message from control device 230, and may provide the response message to telematics device 250 via wireless interface 440. In this way, expansion device 210 may provide information associated with a particular control device 230 and/or a particular VCN 220 with which telematics device 250 may not be capable of communicating (e.g., via telematics device interface 420).

In some implementations, expansion device 210 may receive, via a fourth interface, information associated with peripheral device 240. For example, expansion device 210 may communicate with peripheral device 240 via peripheral device interface 450. In some implementations, a cable may connect peripheral device 240 with a port associated with peripheral device interface 450. Additionally, or alternatively, expansion device 210 may provide power to peripheral device 240 via the fourth interface.

In some implementations, expansion device 210 may detect (e.g., based on receiving a signal, based on a pin configuration, or the like) that a particular cable is connected to peripheral device interface 450. Additionally, expansion device 210 (e.g., disconnector component 415) may prevent VCN interface 445 from communicating with a particular control device 230 and/or a particular VCN 220, thereby allowing peripheral device 240 to communicate with the particular control device 230 and/or the particular VCN 220. In this way, expansion device 210 may reduce communication issues associated with the particular control device 230 and/or the particular VCN 220, thereby conserving processor resources.

In some implementations, expansion device 210 may provide information associated with peripheral device 240 (e.g., sensor information, location information, or the like) to telematics device 250 via wireless interface 440. In this way, telematics device 250 may provide the information, associated with peripheral device 240, to telematics monitoring device 260. Additionally, in this way, expansion device 210 may enable additional information to be provided to telematics monitoring device 260 based on particular peripheral devices 240 that are connected to expansion device 210.

In this way, expansion device 210 may extend a functionality associated with telematics device 250. For example, expansion device 210 may communicate with additional control devices 230 and/or VCNs 220 (i.e., control devices 230 and/or VCNs 220 with which telematics device 250 is not configured to directly communicate), and may provide information associated with the additional control devices 230 and/or VCNs 220 to telematics device 250 via wireless interface 440. Additionally, expansion device 210 may enable peripheral devices 240 to communicate with expansion device 210, control devices 230, and/or VCNs 220. Additionally, expansion device 210 may provide information associated with peripheral devices 240 to telematics device 250 via wireless interface 440. Additionally, expansion device 210 may enable telematics device 250 to be used in association with particular vehicles (e.g., heavy-duty trucks, dual-battery vehicles, and/or vehicles having a battery associated with a particular voltage).

Additionally, expansion device 210 may provide power to telematics device 250 in the event that a power supply associated with a vehicle is unavailable and/or incapable of providing power, thereby allowing telematics device 250 to provide information (e.g., location information) to telematics monitoring device 260. In this way, an organization may utilize a particular telematics device 250 in association with expansion device 210, and may extend the functionality of telematics device 250 as desired. Additionally, in this way, expansion device 210 may conserve processor and/or memory resources of telematics monitoring device 260, and/or may conserve network resources by reducing a quantity of information provided to telematics monitoring device 260 (e.g., information in which the organization may not be interested).

Although FIG. 5 shows example blocks of process 500, in some implementations, process 500 may include additional blocks, fewer blocks, different blocks, or differently arranged blocks than those depicted in FIG. 5. Additionally, or alternatively, two or more of the blocks of process 500 may be performed in parallel.

Implementations described herein may enable a telematics device to interface with an expansion device, thereby extending the functionality of the telematics device. In this way, an organization may extend the functionality of the telematics device as desired, thereby conserving network resources (e.g., by reducing a quantity of information that is provided to a telematics monitoring device).

The foregoing disclosure provides illustration and description, but is not intended to be exhaustive or to limit the implementations to the precise form disclosed. Modifications and variations are possible in light of the above disclosure or may be acquired from practice of the implementations.

As used herein, the term component is intended to be broadly construed as hardware, firmware, or a combination of hardware and software.

Some implementations are described herein in connection with thresholds. As used herein, satisfying a threshold may refer to a value being greater than the threshold, more than the threshold, higher than the threshold, greater than or equal to the threshold, less than the threshold, fewer than the threshold, lower than the threshold, less than or equal to the threshold, equal to the threshold, etc.

To the extent the aforementioned embodiments collect, store, or employ personal information provided by individuals, it should be understood that such information shall be used in accordance with all applicable laws concerning protection of personal information. Additionally, the collection, storage, and use of such information may be subject to consent of the individual to such activity, for example, through well known “opt-in” or “opt-out” processes as may be appropriate for the situation and type of information. Storage and use of personal information may be in an appropriately secure manner reflective of the type of information, for example, through various encryption and anonymization techniques for particularly sensitive information.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code—it being understood that software and hardware can be designed to implement the systems and/or methods based on the description herein.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Furthermore, as used herein, the term “set” is intended to include one or more items (e.g., related items, unrelated items, a combination of related and unrelated items, etc.), and may be used interchangeably with “one or more.” Where only one item is intended, the term “one” or similar language is used. Also, as used herein, the terms “has,” “have,” “having,” or the like are intended to be open-ended terms. Further, the phrase “based on” is intended to mean “based, at least in part, on” unless explicitly stated otherwise.

What is claimed is:

1. A device, comprising:
one or more processors to:
receive, via a first interface, vehicle information associated with multiple vehicle communication networks;
provide, via a second interface, a first subset of the vehicle information to a telematics device,
the first subset of the vehicle information being associated with one or more vehicle communication networks, of the multiple vehicle communication networks, with which the telematics device is configured to communicate,
the second interface being an on-board diagnostics (OBD) interface; and
provide, via a third interface, a second subset of the vehicle information to the telematics device,
the telematics device to provide the first subset of the vehicle information and the second subset of the vehicle information to another device via a cellular network,
the third interface being a wireless interface.

2. The device of claim 1, where the one or more processors are further to:
receive, via a fourth interface, information associated with a peripheral device,
the peripheral device to communicate with the device via the fourth interface; and
provide, via the third interface, the information associated with the peripheral device to the telematics device based on receiving the information associated with the peripheral device.

3. The device of claim 1, where the one or more processors are further to:
receive, via the first interface, first power from a power supply of a vehicle,
the first power being received at a first voltage; and
provide, via the second interface, second power to the telematics device,
the second power being provided at a second voltage,
the second voltage being different than the first voltage.

4. The device of claim 1, where the first interface or the second interface is a wired interface.

5. The device of claim 1, where the one or more processors are further to:
determine that a diagnostic device is in communication with a vehicle communication network of the one or more vehicle communication networks; and
prevent the telematics device from communicating with the vehicle communication network based on determining that the diagnostic device is in communication with the vehicle communication network.

6. The device of claim 1, where the one or more processors are further to:
determine that a peripheral device is in communication with a vehicle communication network, of the one or more vehicle communication networks, via a fourth interface; and
prevent the device from communicating with the vehicle communication network based on determining that the peripheral device is in communication with the vehicle communication network.

7. The device of claim 1, where the one or more processors are further to:
determine that the device is not in communication with a vehicle via the first interface; and
provide power to the telematics device based on determining that the device is not in communication with the vehicle.

8. A non-transitory computer-readable medium storing instructions, the instructions comprising:
one or more instructions that, when executed by one or more processors of a device, cause the one or more processors to:
receive, via a first interface, vehicle information associated with a plurality of vehicle communication networks,
the first interface being associated with a first on-board diagnostics (OBD) interface;
provide, via a second interface, a first subset of the vehicle information to a telematics device,
the second interface being associated with a second OBD interface,
the telematics device being configured to communicate with a first plurality of control devices associated with one or more of the plurality of vehicle communication networks,
the telematics device to communicate with the first plurality of control devices via the second interface, and
the first subset of the vehicle information being associated with the first plurality of control devices; and
provide, via a third interface, a second subset of the vehicle information to the telematics device,
the third interface being associated with a wireless interface,
the telematics device not being configured to communicate with a second plurality of control devices associated with one or more of the plurality of vehicle communication networks,
the second subset of the vehicle information being associated with the second plurality of control devices,
the telematics device to provide the first subset of the vehicle information and the second subset of the vehicle information to another device via a network.

9. The non-transitory computer-readable medium of claim 8, where the one or more instructions, when executed by the one or more processors, further cause the one or more processors to:
determine that a voltage associated with a first power supply of the vehicle satisfies a threshold voltage; and
provide power to the telematics device based on determining that the voltage associated with the first power supply of the vehicle satisfies the threshold voltage,
the power being associated with a second power supply of the device.

10. The non-transitory computer-readable medium of claim 8, where the one or more instructions, when executed by the one or more processors, further cause the one or more processors to:
receive, via the third interface, first information from the telematics device;
provide, via the first interface, the first information to one or more control devices, of the second plurality of control devices, based on receiving the first information;
receive, via the first interface, second information from the one or more control devices, of the second plurality of control devices, based on providing the first information; and
provide, via the third interface, the second information to the telematics device based on receiving the second information.

11. The non-transitory computer-readable medium of claim 8, where the one or more instructions, when executed by the one or more processors, further cause the one or more processors to:
detect that a diagnostic device is in communication with one or more control devices of the first plurality of control devices; and
prevent the telematics device from communicating with the one or more control devices, of the first plurality of control devices, based on detecting that the diagnostic device is in communication with the one or more control devices.

12. The non-transitory computer-readable medium of claim 8, where the one or more instructions, when executed by the one or more processors, further cause the one or more processors to:
receive, via a fourth interface, information associated with a peripheral device; and
provide, via the third interface, the information associated with the peripheral device to the telematics device based on receiving the information associated with the peripheral device.

13. The non-transitory computer-readable medium of claim 8, where the one or more instructions, when executed by the one or more processors, further cause the one or more processors to:
receive, via the third interface, a message from the telematics device; and
provide, via the second interface, the message to the second plurality of control devices based on receiving the message.

14. The non-transitory computer-readable medium of claim 8, where the one or more instructions, when executed by the one or more processors, further cause the one or more processors to:
receive, via the third interface, configuration information from the telematics device; and
update a configuration of the device based on receiving the configuration information.

15. A method, comprising:
receiving, by a device and via a first interface, vehicle information associated with a plurality of vehicle communication networks;
providing, by the device, and via a second interface, a first subset of the vehicle information to a telematics device,
the first subset of the vehicle information being associated with one or more vehicle communication networks, of the plurality of vehicle communication networks, with which the telematics device is configured to communicate,
the second interface being an on-board diagnostics (OBD) interface; and
providing, by the device and via a third interface, a second subset of the vehicle information to the telematics device to permit the telematics device to provide the vehicle information to another device,
the third interface being a wireless interface.

16. The method of claim 15, further comprising:
receiving, via a fourth interface, information associated with a peripheral device; and
providing, via the third interface, the information associated with the peripheral device to the telematics device based on receiving the information associated with the peripheral device.

17. The method of claim 15, where the second subset of the vehicle information is associated with one or more vehicle communication networks, of the plurality of vehicle communication networks, with which the telematics device is not configured to communicate.

18. The method of claim 15, further comprising:
receiving, via the first interface, first power from a power supply associated with a vehicle; and
providing, via the second interface, second power to the telematics device based on receiving the first power,
the second power being provided at a first voltage that is different than a second voltage associated with the power supply of the vehicle.

19. The method of claim 15, further comprising:
determining that a diagnostic device is in communication with a vehicle communication network of the one or more vehicle communication networks; and
preventing the telematics device from communicating with the vehicle communication network based on determining that the diagnostic device is in communication with the vehicle communication network.

20. The method of claim 15, further comprising:
establishing a wireless connection to the telematics device via the third interface.
